(19) United States
(12) Patent Application Publication
(10) Pub. No.: US 2019/0375249 A1
(43) Pub. Date: Dec. 12, 2019

(54) Pneumatic Tire

(71) Applicant: The Yokohama Rubber Co., LTD., Minato-ku, Tokyo (JP)

(72) Inventor: Masaya Mita, Hiratsuka-shi, Kanagawa (JP)

(21) Appl. No.: 16/470,176

(22) PCT Filed: Dec. 14, 2017
(86) PCT No.: PCT/JP2017/044972

§ 371 Date: Jun. 14, 2019

(30) Foreign Application Priority Data
Dec. 15, 2016 (JP) 2016-243666

(51) Int. Cl. B60C 13/00; B60C 15/00; B60C 15/04; B60C 9/02; B60C 15/06

(52) U.S. Cl. CPC B60C 13/00; B60C 15/0027; B60C 15/0603; B60C 9/02; B60C 15/04

(57) ABSTRACT

A pneumatic tire is provided. A tire outer surface contour line from a sidewall portion to a bead portion has a center on a tire axial line passing a tire maximum width position and has a contour arc, which passes the tire maximum width position and is connected to a bead heel portion of the bead portion; and a contour straight line, which has one end connected to the contour arc and the other end connected to the bead heel portion. A connection part of the contour straight line and the bead heel portion is set such that a height H1 in a tire radial direction from a bead toe to the tire maximum width position and a height H5 in the tire radial direction from the bead toe fall with a range of (0.3×H1)≥H5≥(0.25×H1). A connection part of the contour arc and the contour straight line is set such that a height H2 in the tire radial direction from the bead toe falls within a range of (0.9×H1)≥H2≥(0.75×H1).

### TECHNICAL FIELD

The present technology relates to a pneumatic tire.

### BACKGROUND ART

A pneumatic tire is mounted on a rim wheel by fitting a bead portion including a bead core, which is an annular member formed of a bundle of a plurality of bead wires, into a rim of the rim wheel. The bead portion is a portion that is directly mounted on the rim wheel at the time of mounting the pneumatic tire on the rim wheel and is a portion that receives various forces at during travel of a vehicle. Thus, in some of the pneumatic tires in the related art, the durability of the bead portion and a periphery of members positioned near the bead portion is improved. For example, in a pneumatic tire described in Japan Unexamined Patent Publication No. 2001-113920, a tire outer surface contour line from a sidewall portion to a bead portion is formed to include a first linear portion extending inward in a tire radial direction through a tire maximum width and a second linear portion extending obliquely inward in a tire axial direction from an inner end of the first linear portion to a bead portion, and an outer end of a folded back end portion of a carcass ply is positioned within a predetermined range. In this manner, the durability of the bead portion is improved.

Further, in recent years, reduction in the weight of the pneumatic tire has been demanded. As a method of reducing the weight, thinning of sidewalls can be exemplified. However, when the sidewalls are reduced in thickness, damage is liable to be caused when the sidewalls are brought into contact with a curb and the like. Thus, some of the pneumatic tires in the related art employ a configuration that is less liable to be damaged even when the sidewalls are reduced in thickness. For example, in a pneumatic tire described in Japan Unexamined Patent Publication No. H07-186636, sidewalls are reduced in thickness, and cut resistance is improved by defining a profile of a position of each of the sidewalls on a side closer to an outer end in a tire radial direction. Further, in some of the pneumatic tires in the related art, durability is improved while reducing weight. For example, in a pneumatic tire described in Japan Unexamined Patent Publication No. 2001-233022, a contour line of a tire outer surface between a tire cross-sectional width point and a separating point from a flange is formed to include a projecting part, which projects with respect to a reference arc, and a recessed part, which is recessed with respect to the reference arc.

In recent years, reduction in the weight of the pneumatic tire has further been demanded. As a method of reducing weight, thinning of sidewall portions is considered. However, when the sidewall portions are reduced in thickness, a part of rim cushion is repeatedly deformed when the pneumatic tire is in use, and wear and the like are liable to be caused, which may degrade durability. As in Japan Unexamined Patent Publication No. 2001-233022, reduction in weight and improvement in durability can be achieved to some extent by forming the contour line of the tire outer surface to include the projecting part and the recessed part. However, since the projecting part is provided in Japan Unexamined Patent Publication No. 2001-233022, there is room for improvement with regard to reduction in weight. As described above, it is very difficult to achieve both reduction in weight and durability.

### SUMMARY

The present technology has been made in view of the above and provides a pneumatic tire that can achieve reduction in weight while ensuring durability.

A pneumatic tire according to an embodiment of the present technology includes a pair of sidewall portions provided on both sides of a tire equatorial plane in a tire lateral direction, a pair of bead portions provided inward of the pair of sidewall portions in the tire lateral direction, each of the pair of bead portions including a bead core formed in an annular shape, a bead filler provided outward of the bead core in a tire radial direction, and a carcass provided over a space between the pair of bead portions, the carcass being folded back from an inner side to an outer side of the bead core in the tire lateral direction. A tire outer surface contour line, which is a contour line from the sidewall portion to the bead portion on an outer surface in the tire lateral direction in a meridian cross-section, has an arc, which has a center on a tire axial line passing a tire maximum width position, passes the tire maximum width position and is connected to a bead heel portion of the bead portion; and a straight line, which has one end connected to the arc and the other end connected to the bead heel portion. A region of the arc from a position at which the straight line is connected and the tire maximum width position forms the tire outer surface contour line. A connection part of the arc and the bead heel portion and a connection part of the straight line and the bead heel portion are set such that a height H1 in the tire radial direction from a bead portion innermost end, which is an end on an innermost side of the bead portion in the tire radial direction, to the tire maximum width position and a height H5 in the tire radial direction from the bead portion innermost end fall within a range of (0.3×H1)≥H5≥(0.25×H1). A connection part of the arc and the straight line is set such that the height H1 in the tire radial direction from the bead portion innermost end to the tire maximum width position and a height H2 in the tire radial direction from the bead portion innermost end fall within a range of (0.9×H1)≥H2≥(0.75×H1).

In the above-mentioned pneumatic tire, preferably a relationship of a thickness W1 of the sidewall portion in the tire maximum width position, a thickness W2 of the sidewall portion at a position of an end of the bead filler outward in the tire radial direction, and a thickness W3 of the bead portion at a position of an end of the bead core outward in the tire radial direction falls within a range of (2.8×W2)≥W3 ≥(2.1×W2) and falls within a range of (1.7×W1)≥W2≥(1.2×W1).

In the above-mentioned pneumatic tire, preferably a height H3 in the tire radial direction from the bead portion innermost end to an end of a turned-up portion, which is a portion folded back outward of the bead core in the tire lateral direction in the carcass, on an outer side in the tire lateral direction and the height H1 in the tire radial direction from the bead portion innermost end to the tire maximum width position fall within a range of (0.75×H1)≥H3≥(0.65×H1).

In the above-mentioned pneumatic tire, preferably a height H4 in the tire radial direction from the bead portion innermost end to the end of the bead filler outward in the tire radial direction and the height H1 in the tire radial direction from the bead portion innermost end to the tire maximum width position fall within a range of (0.6×H1)≥H4≥(0.5×H1).

In the above-mentioned pneumatic tire, preferably an air penetration preventing layer is provided on an inner surface of the pneumatic tire, and preferably a thermoplastic resin film is used for the air penetration preventing layer.

The pneumatic tire according to an embodiment of the present technology can exert an effect of reducing in weight while ensuring durability.

### BRIEF DESCRIPTION OF DRAWINGS

FIG. 1 is a meridian cross-sectional view for illustrating main parts of a pneumatic tire according to an embodiment.

FIG. 2 is a detailed view of portion A of FIG. 1.

FIG. 3 is a schematic view of a contour straight line illustrated in FIG. 2.

FIG. 4A is a table for showing the results of performance tests of pneumatic tires.

FIG. 4B is a table for showing the results of performance tests of pneumatic tires.

FIG. 4C is a table for showing the results of performance tests of pneumatic tires.

FIG. 4D is a table for showing the results of performance tests of pneumatic tires.

### DETAILED DESCRIPTION

Pneumatic tires according to embodiments of the present technology are described in detail below with reference to the drawings. However, the present technology is not limited to the embodiments. Further, constituents of the following embodiments include elements that are substantially equivalent or that can be substituted or easily conceived by one skilled in the art.

In the following description, “tire radial direction” refers to a direction orthogonal to a rotation axis of a pneumatic tire 1. “Inward in the tire radial direction” refers to a direction toward the rotation axis in the tire radial direction. “Outward in the tire radial direction” refers to a direction away from the rotation axis in the tire radial direction. Further, “tire circumferential direction” refers to a circumferential direction with the rotation axis as the center axis. Additionally, “tire lateral direction” refers to a direction parallel with the rotation axis. “Inward in the tire lateral direction” refers to a direction toward a tire equatorial plane (tire equator line) CL in the tire lateral direction.

“Outward in the tire lateral direction” refers to a direction away from the tire equatorial plane CL in the tire lateral direction. “Tire equatorial plane CL” refers to a plane orthogonal to the rotation axis of the pneumatic tire 1 and passes through the center of the tire width of the pneumatic tire 1. “Tire width” is a width in the tire lateral direction between components positioned outward in the tire lateral direction, in other words, a distance between the components that are the most distant from the tire equatorial plane CL in the tire lateral direction. “Tire equator line” refers to a line along the tire circumferential direction of the pneumatic tire 1, which lies on the tire equatorial plane CL.

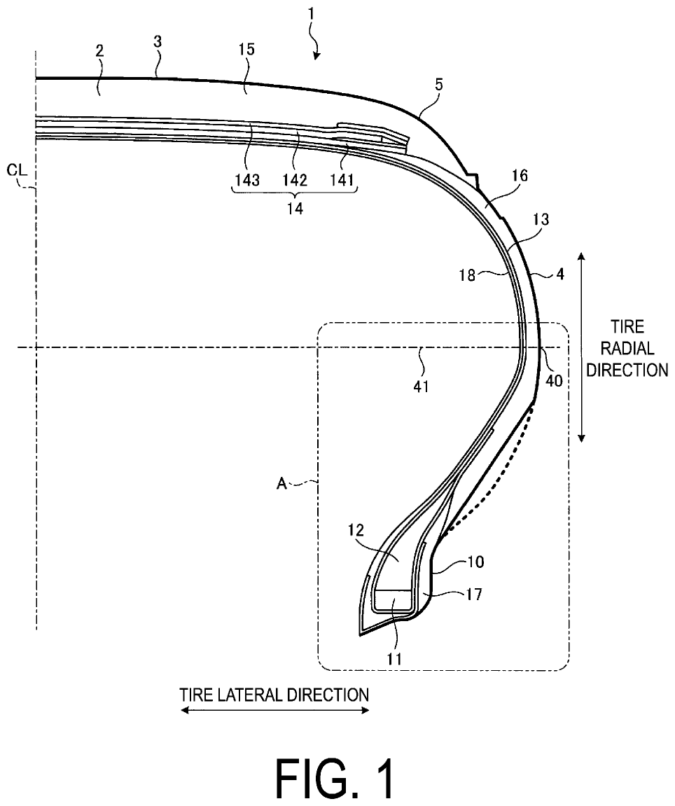

FIG. 1 is a meridian cross-sectional view for illustrating main parts of the pneumatic tire 1 according to an embodiment. As viewed in a meridian cross-section, the pneumatic tire 1 illustrated in FIG. 1 is provided with a tread portion 2, which is formed of tread rubber 15, in the outermost portion in the tire radial direction. An outer circumferential surface of the tread portion 2 forms a contour of the pneumatic tire 1. The outer circumferential surface of the tread portion 2 is a surface that comes into contact with a road surface during travel of a vehicle on which the pneumatic tire 1 is mounted, and the outer circumferential surface is formed as a tread surface 3. In the tread surface 3, a plurality of grooves such as circumferential main grooves (not illustrated) extending in the tire circumferential direction and lug grooves (not illustrated) extending in the tire lateral direction are formed.

On each of both ends of the tread portion 2 in the tire lateral direction, a shoulder portion 5 is positioned. A sidewall portion 4, which is formed of sidewall rubber 16, is provided inward of the shoulder portion 5 in the tire radial direction. In other words, two sidewall portions 4 are provided on both sides of the pneumatic tire 1 in the tire lateral direction. That is, a pair of sidewall portions 4 are provided on both sides of the tire equatorial plane CL in the tire lateral direction.

Bead portions 10 are provided inward of the pair of sidewall portions 4 in the tire radial direction, which are positioned on both sides in the tire lateral direction. Similarly to the sidewall portions 4, two bead portions are provided on both sides of the tire equatorial plane CL. That is, a pair of bead portions 10 are provided on both sides of the tire equatorial plane CL in the tire lateral direction. Each of the bead portions 10 includes a bead core 11, and a bead filler 12 is provided outward of the bead core 11 in the tire radial direction. The bead core 11 is an annular member formed of a bundle of a plurality of bead wires, and the bead filler 12 is a rubber member provided outward of the bead core 11 in the tire radial direction.

Further, a plurality of belt layers 14 are provided inward of the tread portion 2 in the tire radial direction. The belt layers 14 include a plurality of cross belts 141, 142 and a belt cover 143 and form a multilayer structure. Among those belts, the cross belts 141, 142 are made by performing a rolling process on coating rubber-covered belt cords made of steel or an organic fiber material. The cross belts 141, 142 have a belt angle, as an absolute value, ranging from 20 degrees to 55 degrees. Further, the plurality of cross belts 141, 142 have different belt angles defined as inclination angles of the fiber direction of the belt cords with respect to the tire circumferential direction and are layered so that the fiber directions of the belt cords intersect each other, i.e., formed as a crossply structure. Further, the belt cover 143 is obtained by performing a rolling process on one or a plurality of coating rubber-covered cords formed of steel or an organic fiber material and forms a belt angle falling within a range of from 0 degree to 10 degrees as an absolute value. Further, one or a plurality of cords forming the belt cover 143 are wound in a spiral manner for a plurality of turns in the tire circumferential direction on the outer circumferential surfaces of the cross belts 141, 142. In this manner, the belt cover 143 is disposed in a layered manner outward of the cross belts 141, 142 in the tire radial direction.

A carcass 13 including the cords of the radial ply is continuously provided inward of the belt layer 14 in the tire radial direction and on the tire equatorial plane CL side of the sidewall portion 4. The carcass 13 has a single layer structure made of one carcass ply or a multilayer structure made of a plurality of carcass plies and is provided over a space between the pair of bead portions 10. That is, the carcass 13 extends between the bead cores 11 provided on both sides in the tire lateral direction and forms the framework of the pneumatic tire 1. Specifically, the carcass 13 is provided from one bead portion 10 to the other bead portion 10 of the bead portions 10 positioned on both sides in the tire lateral direction and turns back along the bead cores 11 from the inner sides to the outer sides of the bead cores 11 in the tire lateral direction at the bead portions 10 so as to wrap the bead cores 11 and the bead fillers 12. Further, the carcass ply of the carcass 13 is obtained by performing a rolling process on coating rubber-covered carcass cords made of steel or an organic fiber material such as aramid, nylon, and polyester. The carcass ply has a carcass angle being an inclination angle of the fiber direction of the carcass cords with respect to the tire circumferential direction, which falls within a range of from 80 degrees to 95 degrees as an absolute value.

A rim cushion rubber 17, which forms a contact surface of the bead portion 10 with respect to a rim flange, is provided inward in the tire radial direction and outward in the tire lateral direction of the bead core 11 and the turned back portion of the carcass 13 of the bead portion 10. Further, on the inner surface of the pneumatic tire 1, an innerliner 18 being an air penetration preventing layer is provided. The innerliner 18 is formed along the carcass 13 on the inner side of the carcass 13 or on the inner side of the carcass 13 in the pneumatic tire 1.

For the innerliner 18, a thermoplastic resin film, which is constituted by a thermoplastic resin or a thermoplastic elastomer composition obtained by blending an elastomer with a thermoplastic resin, is used. In general, butyl rubber is used for the innerliner of the pneumatic tire in many cases. However, the thermoplastic resin film used for the innerliner 18 of the pneumatic tire 1 according to the present embodiment has an air permeability T_{Y} smaller than an air permeability T_{B} of butyl rubber. Specifically, the butyl rubber has the air permeability T_{B} of 4.5−5.5×10⁻⁹ cc·cm/cm³·sec·cmHg, whereas the thermoplastic resin film has the air permeability T_{Y} of 1.5−3.0×10⁻¹¹ cc·cm/cm³·sec·cmHg. Thus, the thermoplastic resin film has the air permeability Ty smaller than the air permeability TB of the butyl rubber.

Examples of a thermoplastic resin that can be used for the innerliner 18 include polyamide resins (nylon 6 (N6), nylon 66 (N66), nylon 46 (N46), nylon 11 (N11), nylon 12 (N12), nylon 610 (N610), nylon 612 (N612), nylon 6/66 copolymers (N6/66), nylon 6/66/610 copolymers (N6/66/610), nylon MXD6, nylon 6T, nylon 6/6T copolymers, nylon 66/PP copolymers, and nylon 66/PPS copolymers); polyester resins (aromatic polyesters such as polybutylene terephthalate (PBT), polyethylene terephthalate (PET), polyethylene isophthalate (PEI), polybutylene terephthalate/tetramethylene glycol copolymers, PET/PEI copolymers, polyarylate (PAR), polybutylene naphthalate (PBN), liquid crystal polyester, and polyoxyalkylene diimide diacid/polybutylene terephthalate copolymers); polynitrile resins (polyacrylonitrile (PAN), polymethacrylonitrile, acrylonitrile/styrene copolymers (AS), (meth)acrylonitrile/styrene copolymers, and (meth)acrylonitrile/styrene/butadiene copolymers); poly(meth)acrylate resins (polymethylmethacrylate (PMMA), polyethylmethacrylate, ethylene ethyl acrylate copolymers (EEA), ethylene/acrylic acid copolymers (EAA), and ethylene methylacrylate resins (EMA)); polyvinyl resins (vinyl acetate (EVA), polyvinyl alcohol (PVA), vinyl alcohol/ethylene copolymers (EVOH), polyvinylidene chloride (PVDC), polyvinyl chloride (PVC), vinyl chloride/vinylidene chloride copolymers, and vinylidene chloride/methylacrylate copolymers); cellulose resins (cellulose acetate and cellulose acetate butyrate); fluorine resins (polyvinylidene fluoride (PVDF), polyvinyl fluoride (PVF), polychlorofluoroethylene (PCTFE), and tetrafluoroethylene/ethylene copolymers (ETFE)); imide resins (aromatic polyimide (PI)); and the like.

Examples of elastomer used for the innerliner 18 include diene rubbers and hydrogenates thereof (NR, IR, epoxidized natural rubber, SBR, BR (high-cis BR and low-cis BR), NBR, hydrogenated NBR, and hydrogenated SBR); olefin rubbers (ethylene propylene rubber (EPDM, EPM), maleated ethylene propylene rubber (M-EPM); butyl rubber (IIR); isobutylene and aromatic vinyl or diene monomer copolymers; acrylic rubber (ACM); ionomer; halogen-containing rubbers (Br-IIR, Cl-IIR, brominated copolymer of isobutylene/para-methyl styrene (Br-IPMS), chloroprene rubber (CR), hydrin rubber (CHC, CHR), chlorosulfonated polyethylene (CSM), chlorinated polyethylene (CM), and maleated chlorinated polyethylene (M-CM)); silicone rubbers (methyl vinyl silicone rubber, dimethyl silicone rubber, and methyl phenyl vinyl silicone rubber); sulfur-containing rubbers (polysulfide rubber); fluororubbers (vinylidene fluoride rubbers, fluorine-containing vinyl ether rubbers, tetrafluoroethylene-propylene rubbers, fluorine-containing silicone rubbers, and fluorine-containing phosphazene rubbers); thermoplastic elastomers (styrene elastomers, olefin elastomers, polyester elastomers, urethane elastomers, and polyamide elastomers); and the like.

Further, in the thermoplastic elastomer composition used for the innerliner 18, the composition ratio of the thermoplastic resin component (A) and the elastomer component (B) may be determined as appropriate based on the balance of the thickness and flexibility of the film. The range is preferably from 10/90 to 90/10, more preferably from 20/80 to 85/15 (mass ratio).

Further, another polymer and compounding agent such as a compatibility agent can be mixed in the thermoplastic elastomer composition as a third component in addition to the essential components (A) and (B) described above. The purposes of mixing another polymer are to improve the compatibility between the thermoplastic resin component and the elastomer component, to improve the forming processability of the film of the material, to improve the heat resistance, to reduce cost, and the like. Examples of the material used for the polymer include polyethylene, polypropylene, polystyrene, ABS, SBS, and polycarbonate.

Further, the thermoplastic elastomer composition is obtained by melt-kneading the thermoplastic resin and the elastomer (which is unvulcanized when rubber is used) in advance using a twin screw extruder or the like and dispersing the elastomer component in the thermoplastic resin component that forms a continuous phase. When vulcanizing the elastomer component, a vulcanizing agent may be added while kneading so as to dynamically vulcanize the elastomer. Further, although various compounding agents (except for vulcanizing agents) may be added to the thermoplastic resin or the elastomer component during the kneading, it is preferred to premix the compounding agents prior to the kneading. The kneader used for kneading the thermoplastic resin and the elastomer is not particularly limited, and examples thereof include screw extruders, kneaders, Banbury Mixers, twin screw extruders, and the like. Among these, a twin screw extruder is preferably used for kneading the resin component and the rubber component and for dynamically vulcanizing the rubber component. Furthermore, two or more types of kneaders can be used to perform successive kneading. As a condition for the melt kneading, it is sufficient that the temperature is equal to or higher than the temperature at which the thermoplastic resin melts. Further, it is preferred that a shear rate at the time of kneading is from 2,500 to 7,500 sec⁻¹. A total kneading time is from 30 seconds to 10 minutes. Additionally, when a vulcanizing agent is added, it is preferred that a vulcanization time after the addition is from 15 seconds to 5 minutes. The thermoplastic elastomer composition prepared according to the method described above is formed into a film by molding using a resin extruder or calender molding. A regular film forming process for thermoplastic resins or thermoplastic elastomers can be used for the film forming.

The thin film of the thermoplastic elastomer composition thus obtained has a structure in which the elastomer is dispersed as a discontinuous phase in the matrix of the thermoplastic resin. By adopting the disperse structure in such state, it is possible to set the Young's modulus within a range of from 1 to 500 MPa and to provide appropriate rigidity as the tire component.

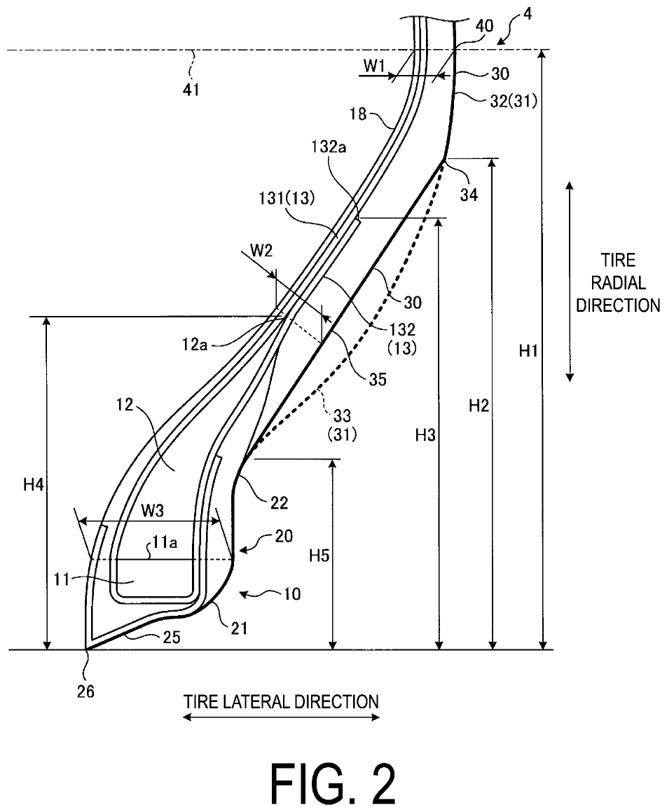

FIG. 2 is a detailed view of portion A of FIG. 1. The bead portion 10 includes a bead heel portion 20 and a bead base 25. Among those, the bead base 25 is a surface of the bead portion 10 inward in the tire radial direction and is formed in an inclined manner with respect to the tire rotation axis in a direction of spreading outward in the tire radial direction as approaching from the inner side to the outer side in the tire lateral direction. An end of the bead base 25 inward in the tire lateral direction is formed as a bead toe 26. The bead toe 26 is a bead portion innermost end which is an end of the bead portion 10 on the innermost side in the tire radial direction. The bead heel portion 20 is a portion from the vicinity of the end of the bead base 25 outward in the tire lateral direction to the surface of the bead portion 10 outward in the tire lateral direction, is formed outward in the tire radial direction from the end of the bead base 25 outward in the tire lateral direction, and faces substantially outward in the tire lateral direction.

Further, in the meridian cross-sectional view, a part near both ends of the bead heel portion 20 in the tire radial direction is formed in an arc shape. An inner arc portion 21 is formed near the end inward in the tire lateral direction, and an outer arc portion 22 is formed near the end outward in the tire lateral direction. Among those, the inner arc portion 21 is formed in an arc shape projecting in an oblique direction between the outer side in the tire lateral direction and the inner side in the tire radial direction in the meridian cross-sectional view, and the inner arc portion 21 is connected to the end of the bead base 25 outward in the tire lateral direction at the bead heel portion 20. In other words, the connection part of the bead heel portion 20 and the bead base 25 is formed into a curve surface projecting toward the surface side of the pneumatic tire 1. Further, in the meridian cross-sectional view, the outer arc portion 22 is formed to have an arc shape projecting in an oblique direction between the inner side in the tire lateral direction and the outer side in the tire radial direction and is formed to have a curve shape projecting inward of the pneumatic tire 1.

A tire outer surface contour line 30 is a contour line of the pneumatic tire 1 in the meridian cross-section on the outer surface from the sidewall portion 4 to the bead portion 10 in the tire lateral direction. The tire outer surface contour line 30 is formed to have a contour arc 31 being an arc passing a tire maximum width position 40 and a contour straight line 35 being a straight line having one end connected to the contour arc 31 and the other end connected to the bead heel portion 20 of the bead portion 10.

Among those, the contour arc 31 has a contour line forming portion 32 and a virtual portion 33, and the contour line forming portion 32 forms the tire outer surface contour line 30. Specifically, the contour arc 31 has a center in a tire axial line 41 that passes the tire maximum width position 40 and is parallel with the tire rotation axis. The contour arc 31 passes the tire maximum width position 40 and is connected to the bead heel portion 20 of the bead portion 10. The contour line forming portion 32 is a portion of the contour arc 31, which is positioned in a range connected with the contour straight line 35 from the tire maximum width position 40. The virtual portion 33 is a portion of the contour arc 31 positioned in a range connected with the bead heel portion 20 from the portion connected with the contour straight line 35.

Further, at the connection part of the contour arc 31 and the bead heel portion 20, connection is achieved by connecting the contour arc 31 with the outer arc portion 22 of the bead heel portion 20. That is, the contour arc 31 has a center positioned in the tire axial line 41 and has an arc shape, which passes the tire maximum width position 40 and is held in contact with the outer arc portion 22 of the bead heel portion 20.

Further, the contour straight line 35 is inclined in the direction from the inner side to the outer side in the tire radial direction as approaching from the inner side to the outer side in the tire lateral direction, and is a straight line held in contact with the outer arc portion 22 of the bead heel portion 20. That is, the contour straight line 35 and the contour arc 31 are connected with the bead heel portion 20 by connection with the outer arc portion 22 of the bead heel portion 20, and hence the contour straight line 35 and the contour arc 31 are connected at substantially the same position with respect to the bead heel portion 20. In other words, the contour straight line 35 is formed as a straight line connecting the two points on the contour arc 31 with respect to the contour arc 31, which corresponds to a so-called chord. The connection part of the contour arc 31 and the bead heel portion 20 and the connection part of the contour straight line 35 and the bead heel portion 20 are set such that a height H5 from the bead toe 26 in the tire radial direction and a height H1 from the bead toe 26 to the tire maximum width position 40 in the tire radial direction fall within a range of (0.3×H1)≥H5≥(0.25×H1).

In a strict sense, the connection part of the contour arc 31 and the bead heel portion 20 and the connection part of the contour straight line 35 and the bead heel portion 20 have different heights in the tire radial direction. However, the height H5 from the bead toe 26 in the tire radial direction falls within the above-mentioned range. Further, similarly to the contour line forming portion 32 and the contour straight line 35 of the contour arc 31, the range from the end on the side on which the inner arc portion 21 is positioned to the position held in contact with the contour straight line 35 in the outer arc portion 22 of the bead heel portion 20 also forms the tire outer surface contour line 30. Meanwhile, the range between the position held in contact with the contour straight line 35 and the position held in contact with the contour arc 31 in the outer arc portion 22 has a virtual arc for defining the shape of the contour arc 31, similarly to the virtual portion 33 of the contour arc 31.

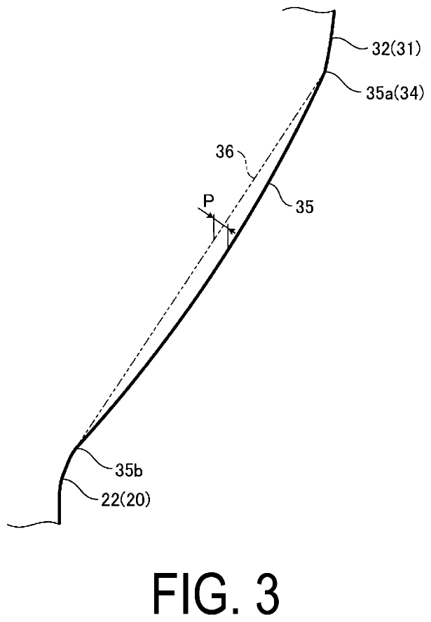

FIG. 3 is a schematic view of the contour straight line 35 illustrated in FIG. 2. Further, in the meridian cross-sectional view, the contour straight line 35 may not be formed as a straight line in a strict sense. A reference straight line 36 is a straight line connecting both the ends to which the contour straight line 35 is connected, that is, connecting a connection position 35a with the contour arc 31 and a connection position 35b with the bead heel portion 20 on the contour straight line 35. The contour straight line 35 may have a margin amount P with respect to the reference straight line 36, which falls within a range of 1.5 mm. That is, the contour straight line 35 may be bent or curved within a range of 3.0 mm in the direction orthogonal to the reference straight line 36 and may be uneven within the above-mentioned range.

Note that, the definition of the height from the bead toe 26 in the tire radial direction is made under a state after the pneumatic tire 1 is subjected to vulcanization molding in a mold for vulcanization molding and is made under a state in which a load is not applied before the pneumatic tire 1 is mounted on a specified rim. Specifically, the height from the bead toe 26 in the tire radial direction is defined under an unloaded state by assuming that the distances in the tire lateral direction between the inner arc portions 21 of the bead heel portions 20 of the bead portions 10 positioned on both sides in the tire lateral direction are the distances when the pneumatic tire 1 is mounted on the specified rim. Here, “specified rim” refers to an “applicable rim” defined by JATMA (the Japan Automobile Tyre Manufacturers Association, Inc.), a “Design Rim” defined by TRA (the Tire & Rim Association, Inc.), or a “Measuring Rim” defined by ETRTO (the European Tyre and Rim Technical Organisation).

Further, the height from the bead toe 26 in the tire radial direction may be defined under an unloaded state by assuming that the distance between the intersection point of the line obtained by extending the surface inward in the tire lateral direction, which faces outward in the tire lateral direction in the bead heel portion 20 on each of the bead portions 10 positioned on both sides in the tire lateral direction, and the line extending the bead base 25 outward in the tire lateral direction is the distance under the state the pneumatic tire 1 is mounted on the specified rim. Further, other definitions described later are also made under the unloaded state by assuming that the distance in the tire lateral direction between the inner arc portions 21 of the bead heel portions 20 positioned on both sides in the tire lateral direction or the distance in the tire lateral direction between the intersection points of the extension lines of the surface facing outward in the tire lateral direction and the bead base 25 in the bead heel portion 20 is the distance under the state in which the pneumatic tire 1 is mounted on the specified rim.

The contour straight line 35 is connected to the bead heel portion 20 at the height H5 from the bead toe 26 in the tire radial direction, which falls within the above-mentioned range and extends outward in the tire lateral direction from the position to which the bead heel portion 20 is connected while extending outward in the tire radial direction. The contour straight line 35 is connected to the contour arc 31 at the position close to the tire maximum width position 40 inward of the tire maximum width position 40 in the tire radial direction. A connection part 34 being a connection part of the contour straight line 35 and the contour arc 31 is set such that a height H2 from the bead toe 26 in the tire radial direction and the height H1 from the bead toe 26 to the tire maximum width position 40 in the tire radial direction fall within a range of (0.9×H1)≥H2≥(0.75×H1).

In the contour arc 31, the region between the position of the connection part 34 to which the contour straight line 35 is connected and the tire maximum width position 40 is the contour line forming portion 32 forming the tire outer surface contour line 30. In the contour arc 31, the region between the part connected to the outer arc portion 22 of the bead heel portion 20 and the connection part 34 connected to the contour straight line 35 is the virtual portion 33 defining the shape of the contour arc 31.

Further, at the bead portion 10, the carcass 13 passes the inner side of the bead core 11 in the tire lateral direction to the inner side in the tire radial direction and is folded back outward of the bead core 11 in the tire lateral direction. The portion of the bead core 11, which is folded back outward in the tire lateral direction, in the carcass 13 is a turned-up portion 132. The turned-up portion 132 is provided at the position outward of the bead core 11 in the tire radial direction so as to extend outward in the tire radial direction and is overlapped with a body portion 131, which is a portion provided over the region between the pair of bead portions 10 in the carcass 13, from the outer side in the tire lateral direction. The bead filler 12 is provided in a region, which is surrounded by the bead core 11, the body portion 131, and the turned-up portion 132 of the carcass 13, on the outer side of the bead core 11 in the tire radial direction.

Further, the carcass 13 and the innerliner 18 formed along the carcass 13 are formed to be substantially straight at angles close to parallel with the contour straight line 35 along the contour straight line 35 in the region in which the tire outer surface contour line 30 is formed by the contour straight line 35. That is, the carcass 13 has a large radius of curvature and is formed to be substantially straight within a predetermined range from the vicinity of the bead portion 10 to the position close to the tire maximum width position 40 inward of the tire maximum width position 40 in the tire radial direction. More specifically, the carcass 13 is formed to be substantially straight in a range from a vicinity of a position of a bead filler tip 12a being an end of the bead filler 12 outward in the tire radial direction to the position at which the connection part 34 of the contour arc 31 and the contour straight line 35 is positioned in the tire radial direction.

The carcass 13 is set such that a height H3 in the tire radial direction from the bead toe 26 to a turned-up tip 132a being an end of the turned-up portion 132 outward in the tire lateral direction and the height H1 from the bead toe 26 to the tire maximum width position 40 in the tire radial direction fall within a range of (0.75×H1)≥H3≥(0.65×H1). The bead filler 12 is set such that a height H4 from the bead toe 26 to the bead filler tip 12a of the bead filler 12 in the tire radial direction and the height H1 from the bead toe 26 to the tire maximum width position 40 in the tire radial direction fall within a range of (0.6×H1)≥H4≥(0.5×H1).

As described above, the sidewall portion 4 and the bead portion 10 in which the tire outer surface contour line 30, the carcass 13, and the bead filler 12 are formed have a predetermined thickness within a predetermined range. Specifically, the sidewall portion 4 is set such that a relationship between a thickness W1 of the sidewall portion 4 at the tire maximum width position 40 and a thickness W2 of the sidewall portion 4 at the position of the bead filler tip 12a satisfies a range of (1.7×W1)≥W2≥(1.2×W1). Further, the sidewall portion 4 and the bead portion 10 is set such that a relationship between the thickness W2 of the sidewall portion 4 at the position of the bead filler tip 12a and a thickness W3 of the bead portion 10 at the position of a bead core outer circumferential surface 11a being an end of the bead core 11 outward in the tire radial direction satisfies a range of (2.8×W2)≥W3≥(2.1×W2).

Note that, in this case, the thickness W1 of the sidewall portion 4 at the tire maximum width position 40 and the thickness W3 of the bead portion 10 at the position of the bead core outer circumferential surface 11a are thicknesses in the tire lateral direction. Further, in the meridian cross-sectional view, the thickness W2 of the sidewall portion 4 at the position of the bead filler tip 12a is orthogonal to the contour straight line 35 and is a thickness of the sidewall portion 4 at the position passing the bead filler tip 12a.

Further, when the pneumatic tire 1 is viewed in the meridian cross-section, the bead core outer circumferential surface 11a of the bead core 11 in this case is a surface indicated with a virtual straight line that is in contact with the portion of the plurality of bead wires arrayed in line at the position outward of the bead core 11 in the tire radial direction to form the surface of the bead core 11, the portion being exposed on the surface of the bead core 11.

The pneumatic tire 1 according to the present embodiment is the pneumatic tire 1 mainly used for a passenger vehicle. When the pneumatic tire 1 is mounted on a vehicle, a rim wheel is fitted into the bead portion 10, and the pneumatic tire 1 is mounted on the vehicle under a state of being mounted to the rim and inflated. When the vehicle on which the pneumatic tire 1 is mounted travels, the pneumatic tire 1 rotates while the tread surface 3 of the tread surface 3 located at the bottom comes into contact with the road surface. The vehicle travels by transmitting a driving force and a braking force to the road surface with a friction force between the tread surface 3 and the road surface and generating a turning force. For example, when a driving force is transmitted to the road surface, motive power generated in a motor such as an engine included in the vehicle is transmitted to the rim wheel, transmitted from the rim wheel to the bead portion 10, and transmitted to the pneumatic tire 1.

When the pneumatic tire 1 is in use, as described above, loads in various directions act on the respective portions, and those loads are received by the inflated air pressure and the carcass 13 provided as the framework of the pneumatic tire 1. For example, the loads acting in the tire radial direction between the tread portion 2 and the bead portion 10 due to the weight of the vehicle and irregularities of the road surface are mainly received by the inflated air pressure and the carcass 13. As described above, the carcass 13 is provided as a member for receiving the loads acting on the pneumatic tire 1.

Here, the pneumatic tire 1 according to the present embodiment can be reduced in weight because the tire outer surface contour line 30 is configured to include the contour arc 31 and the contour straight line 35. That is, in most cases of the general pneumatic tire 1, the entire tire outer surface contour line 30 is formed to be an arc projecting outward in the tire lateral direction from the position of the tire maximum width position 40 of the sidewall portion 4 to the bead portion 10. In the present embodiment, the tire outer surface contour line 30 include the contour straight line 35. Therefore, in the present embodiment, the distance between the tire outer surface contour line 30 and the carcass 13 is shorter as compared to the case where the entire tire outer surface contour line 30 is formed to be an arc.

That is, in the pneumatic tire 1 according to the present embodiment, the contour straight line 35 forming the tire outer surface contour line 30 is formed as a straight line corresponding to a chord with respect to the contour arc 31. Thus, the portion formed by the contour straight line 35 in the tire outer surface contour line 30 is in a state close to the carcass 13 as compared to the case where the tire outer surface contour line 30 is formed only by the contour arc 31. With this, the rubber between the carcass 13 and the tire outer surface contour line 30 can be reduced in thickness, and the amount of the rubber material between the carcass 13 and the tire outer surface contour line 30 can be reduced as compared to the case where the tire outer surface contour line 30 is formed only by the contour arc 31. Thus, reduction in weight can be achieved.

Further, the tire outer surface contour line 30 has the contour straight line 35, and hence the carcass 13 has a large radius of curvature along the contour straight line 35 in a range in which the tire outer surface contour line 30 is formed by the contour straight line 35 in the carcass 13. Thus, a tension of the carcass 13 is increased, and hence a spring property with respect to the load can be improved. Specifically, a property corresponding to a spring constant of the carcass 13 can be improved. With this, strength with respect to the load in the vicinity of the bead portion 10, which is fitted into the rim wheel and to which a large load is transmitted to the rim wheel, can be improved. Therefore, even when a large load acts in the vicinity of the bead portion 10, the carcass 13 with a large tension can receive the load. Thus, durability can be improved.

Meanwhile, the tire outer surface contour line 30 is formed of the contour line forming portion 32 of the contour arc 31 as well as the contour straight line 35 in the region from the tire maximum width position 40 to the contour straight line 35 in the tire outer surface contour line 30. When the rubber between the carcass 13 and the tire outer surface contour line 30 is reduced in thickness, it is conceived that the position of the tire maximum width position 40 in the tire outer surface contour line 30 is formed to be straight. However, near the tire maximum width position 40 of the sidewall portion 4, deflection is liable to be generated due to the load acting on the pneumatic tire 1. Therefore, in the case where the tire outer surface contour line 30 is straight at the tire maximum width position 40, the straight member is forcefully deflected, and a high stress is liable to be generated, which may cause a failure such as a crack. With respect to this point, in the case where the tire outer surface contour line 30 at the tire maximum width position 40 where deflection is liable to be caused is formed to be an arc, which is likely to be deflected, in advance, deflection can be caused without generating a high stress even when deflection is caused near the tire maximum width position 40 of the sidewall portion 4 due to the load acting on the load acting on the pneumatic tire 1. With this, a failure such as a crack due to deflection caused near the tire maximum width position 40 of the sidewall portion 4 can be suppressed, and durability can be improved.

Further, the connection part 34 of the contour arc 31 and the contour straight line 35 in the tire outer surface contour line 30 is set such that the height H2 from the bead toe 26 in the tire radial direction and the height H1 from the bead toe 26 to the tire maximum width position 40 in the tire radial direction satisfy a range of (0.9×H1)≥H2≥(0.75×H1). Thus, durability can be improved. That is, in the case of H2>(0.9×H1), the connection part 34 of the contour arc 31 and the contour straight line 35 is too close to the tire maximum width position 40, and the sidewall rubber 16 near the tire maximum width position 40 is reduced in thickness. With this, durability is degraded. Further, in the case of (0.75×H1)>H2, the connection part 34 of the contour arc 31 and the contour straight line 35 is too close to the bead portion 10, and the radius of curvature of the carcass 13 positioned in the vicinity of the bead portion 10 cannot be increased. With this, it is difficult to increase the tension of the carcass 13. In this case, it is difficult to improve the spring property of the carcass 13, and hence it is difficult for the carcass 13 to receive a large load acting on the vicinity of the bead portion 10. Thus, it is difficult to improve durability. With regard to this point, in the case where (0.9×H1)≥H2≥(0.75×H1) is satisfied, the tension of the carcass 13 positioned in the vicinity of the bead portion 10 can be increased while the thickness of the sidewall rubber 16 near the tire maximum width position 40 is maintained. Thus, a large load acting on the vicinity of the bead portion 10 can be received by the carcass 13. Thus, durability can be improved.

Further, the connection part of the contour arc 31 and the bead heel portion 20 and the connection part of the contour straight line 35 and the bead heel portion 20 are set such that the height H5 from the bead toe 26 in the tire radial direction and the height H1 from the bead toe 26 to the tire maximum width position 40 in the tire radial direction satisfy a range of (0.3×H1)≥H5≥(0.25×H1). Thus, durability can be improved. That is, in the case where H5>(0.3×H1) is satisfied, the contour straight line 35 is too far away from the bead portion 10, and the radius of curvature of the carcass 13 positioned in the vicinity of the bead portion 10 cannot be increased. With this, it is difficult to increase the tension of the carcass 13 in the vicinity of the bead portion 10. In this case, it is difficult to improve the spring property of the carcass 13, and hence it is difficult for the carcass 13 to receive a large load acting on the vicinity of the bead portion 10. Thus, it is difficult to improve durability. Further, in the case where (0.25×H1)≥H5 is satisfied, the contour straight line 35 is too close to the bead portion 10, and the shape of the bead portion 10 is less likely to match with the shape of the rim wheel fitted into the bead portion 10. With this, when the bead portion 10 is fitted into the rim wheel, a high stress is generated in the bead portion 10, which may cause a risk of degrading the durability of the bead portion 10. With regard to this point, in the case where (0.3×H1)≥H5≥(0.25×H1) is satisfied, the shape of the bead portion 10 is formed so as to match the shape of the rim wheel, and a tension of the carcass 13 in the vicinity of the bead portion 10 is increased. With this, a large load acting on the vicinity of the bead portion 10 is received by the carcass 13. Thus, durability can be improved. As a result, reduction in weight can be achieved while ensuring durability.

Further, the relationship of the thickness W1 of the sidewall portion 4 at the tire maximum width position 40, the thickness W2 of the sidewall portion 4 at the position of the bead filler tip 12a, and the thickness W3 of the bead portion 10 at the position of the bead core outer circumferential surface 11a satisfy a range of (2.8×W2)≥W3≥(2.1×W2) and a range of (1.7×W1)≥W2≥(1.2×W1). Thus, both durability and reduction in weight can be achieved. That is, in the case of (2.1×W2)>W3 or W2>(1.7×W1), the thickness W2 of the sidewall portion 4 at the position of the bead filler tip 12a cannot be reduced effectively. Thus, there may be a risk in that it is difficult to achieve reduction in weight by thinning the rubber thickness at the position at which the contour straight line 35 is formed. That is, in the case of W3≥(2.8×W2) or (1.2×W1)>W2, the thickness W2 of the sidewall portion 4 at the position of the bead filler tip 12a is too small, and there may be a risk of degrading durability due to an excessively small rubber thickness at the position at which the contour straight line 35 is formed. Meanwhile, in the case where (2.8×W2)≥W3 ≥(2.1×W2) and (1.7×W1)≥W2≥(1.2×W1) are satisfied, the thickness W2 of the sidewall portion 4 at the position of the bead filler tip 12a can be reduced effectively while ensuring durability. As a result, reduction in weight can be achieved while ensuring durability more reliably.

Further, the carcass 13 is set such that the height H3 in the tire radial direction from the bead toe 26 to the turned-up tip 132a and the height H1 from the bead toe 26 to the tire maximum width position 40 in the tire radial direction satisfy a range of (0.75×H1)≥H3≥(0.65×H1). Thus, both durability and reduction in weight can be achieved. That is, in the case of H3>(0.75∴H1), the height of the turned-up portion 132 of the carcass 13 in the tire radial direction is too great, and the amount of the turned-up portion 132 is increased. Thus, there may be a risk of increasing the weight unnecessarily. Further, in the case of (0.65×H1)>H3, the height of the turned-up portion 132 of the carcass 13 in the tire radial direction is too small, and the amount of the turned-up portion 132 is reduced. Thus, there may be a risk of excessively lowering strength of the bead portion 10. In this case, there may be a risk in that durability may be degraded. With regard to this point, in the case where (0.75×H1)≥H3≥(0.65×H1) is satisfied, the amount of the turned-up portion 132 can be reduced while ensuring strength of the bead portion 10. Thus, both durability and reduction in weight can be achieved. As a result, reduction in weight can be achieved while ensuring durability more reliably.

Further, the bead filler 12 is set such that the height H4 from the bead toe 26 to the bead filler tip 12a in the tire radial direction and the height H1 from the bead toe 26 to the tire maximum width position 40 in the tire radial direction fall within a range of (0.6×H1)≥H4≥(0.5×H1). Thus, both durability and reduction in weight can be achieved. That is, in the case of H4>(0.6×H1), the height of the bead filler 12 in the tire radial direction is too great, and the volume of the bead filler 12 is too large. Thus, there may be a risk of increasing the weight unnecessarily. Further, in the case of (0.5×H1)>H4, the height of the bead filler 12 in the tire radial direction is too low, and the volume of the bead filler 12 is too small. Thus, there may be a risk of excessively lowering strength of the bead portion 10. In this case, there may be a risk in that durability may be degraded. With regard to this point, in the case where (0.6×H1)≥H4≥(0.5×H1) is satisfied, the volume of the bead filler 12 can be reduced while ensuring strength of the bead portion 10. Thus, both durability and reduction in weight can be achieved. As a result, reduction in weight can be achieved while ensuring durability more reliably. Further, a thermoplastic resin film is used for the innerliner 18. Thus, both ensuring durability and reduction in weight can be achieved more reliably. That is, when the sidewall portion 4 is reduced in thickness for the purpose of reducing the weight, air is liable to be permeated at the time of inflation. However, an air permeability can be suppressed while reducing thickness by using a thermoplastic resin film having a low air permeability for the innerliner 18. As a result, reduction in weight can be achieved while ensuring durability more reliably.

Note that, in the pneumatic tire 1 according to the above-mentioned embodiment, the contour arc 31, the contour straight line 35, and the bead heel portion 20 are connected by connecting the contour arc 31 and the contour straight line 35 to the outer arc portion 22 of the bead heel portion 20. However, the contour arc 31 and the contour straight line 35 may be connected to the bead heel portion 20 in other ways. Only one of the contour arc 31 and the contour straight line 35 may be connected by being held in contact with the outer arc portion 22 of the bead heel portion 20, and the other may be bent and connected to the outer arc portion 22. Both the contour arc 31 and the contour straight line 35 may be bent and connected to the outer arc portion 22. Both the contour arc 31 and the contour straight line 35 are not required to be held in contact with the outer arc portion 22 in a strict manner as long as the contour arc 31, the contour straight line 35, and the bead heel portion 20 are connected loosely as much as possible so as to obtain a state in which the contour arc 31 and the contour straight line 35 are close to the outer arc portion 22.

### EXAMPLES

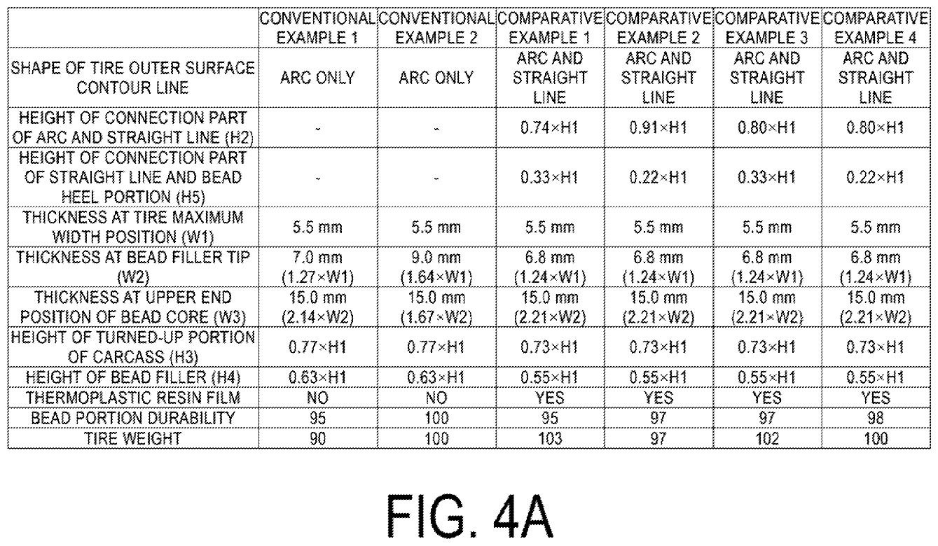

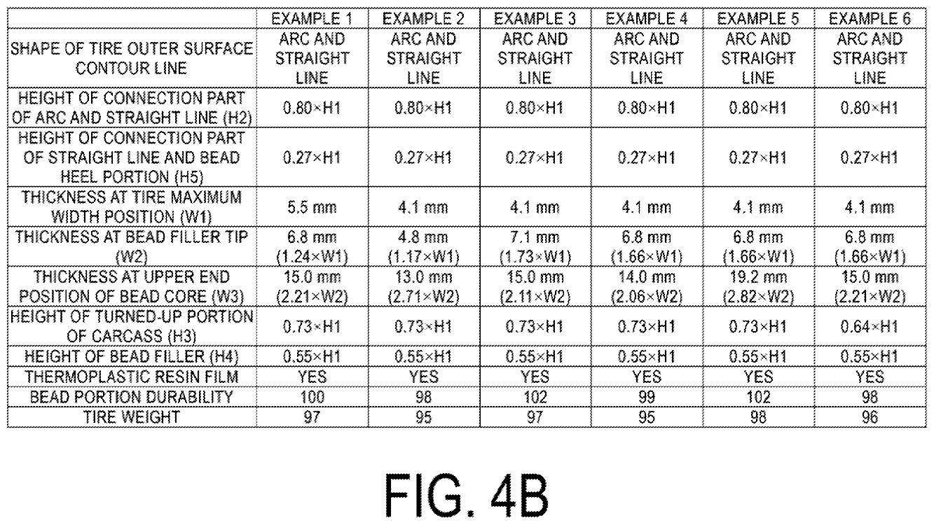

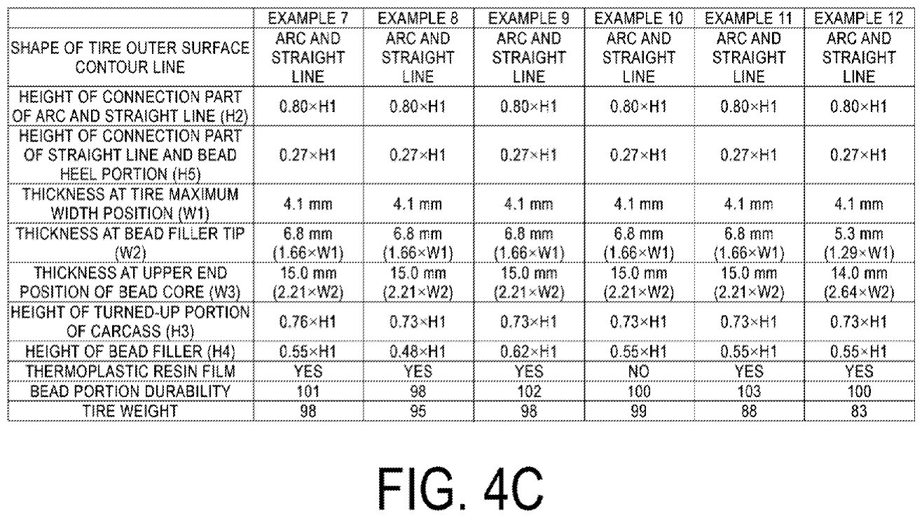

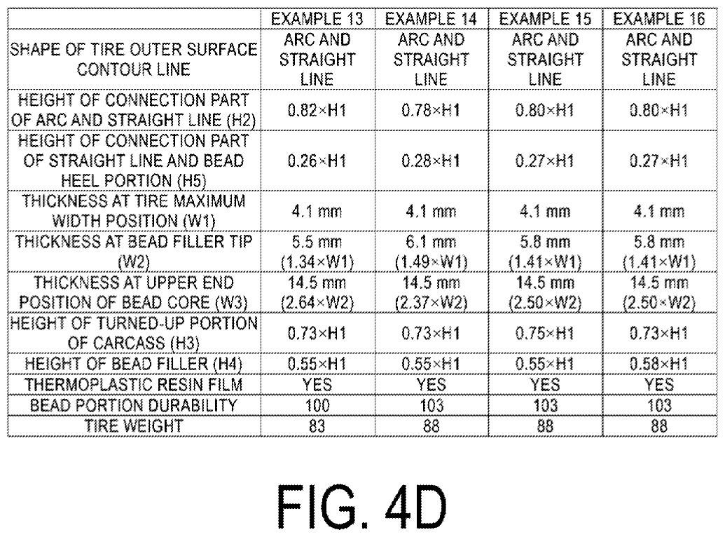

FIG. 4A to FIG. 4D are tables for showing the results of performance tests of pneumatic tires. Now, with regard to the above-mentioned pneumatic tire 1, description is made of performance evaluation tests conducted on pneumatic tires in Conventional Examples, Comparative Examples and the pneumatic tire 1 according to an embodiment of the present technology. The performance evaluation tests were conducted on bead portion durability being the durability of the bead portion 10 and tire weight being the weight of the pneumatic tire 1.

The performance evaluation tests were conducted by using the pneumatic tires 1 with a nominal size of 205/55R16 specified by JATMA. The tests on bead portion durability were conducted in the following manner. The test tire was mounted on a rim wheel being a JATMA standard rim with a size of 16×6.5J, and inflated to a tire internal air pressure of 180 kPa. A load was increased by 15% every four hours from a load of 5.13 kN while the tire traveled at a speed of 81 km/h in an indoor drum testing machine (drum diameter: 1707 mm) conforming to JIS D4230. Then, the tire traveled until a failure was caused. With regard to bead portion durability, a traveling distance before a failure was measured, and the measured traveling distance was indicated by an index with Conventional Example 2 described later as 100. Larger values indicated that a failure was less liable to be caused near the bead portion 10 and that bead portion durability was excellent. Note that, when bead portion durability was indicated by a value equal to or higher than 98, performance equivalent to conventional durability was ensured, and the market requirement was satisfied.

Further, with regard to tire weight, the weight of one test tire was indicated by an index with Conventional Example 2 described later as 100. Smaller values indicated that the weight of one tire was small and that the tire weight was excellent in view of reduction in weight.

The evaluation tests were conducted on twenty-two types of pneumatic tires in Conventional Examples 1 and 2 being examples of conventional pneumatic tires, Examples 1 to 16 being the pneumatic tires 1 according to an embodiment of the present technology, and Comparative Examples 1 to 4 being pneumatic tires for comparison with the pneumatic tires 1 according to an embodiment of the present technology. In each of the pneumatic tires in Conventional Examples 1 and 2 among those pneumatic tires 1, the tire outer surface contour line 30 from the tire maximum width position 40 to the bead portion 10 was formed only by an arc. Further, in each of the pneumatic tires in Comparative Examples 1 to 4, the tire outer surface contour line 30 from the tire maximum width position 40 to the bead portion 10 was formed by an arc and a straight line. However, at the connection part of the arc and the straight line of the tire outer surface contour line 30, the height H2 from the bead toe 26 in the tire radial direction did not fall within the range of (0.9×≥H2≥(0.75×H1). Alternatively, at the connection part of the straight line of the tire outer surface contour line 30 and the bead heel portion 20, the height H5 from the bead toe 26 in the tire radial direction did not fall within the range of (0.3×H1)≥H5≥(0.25×H1).

With regard to this point, in each of Examples 1 to 16 being examples of the pneumatic tires 1 according to an embodiment of the present technology, the tire outer surface contour line 30 from the tire maximum width position 40 to the bead portion 10 was formed by the contour arc 31 and the contour straight line 35. At the connection part 34 of the contour arc 31 and the contour straight line 35, the height H2 from the bead toe 26 in the tire radial direction fell within the range of (0.9×≥H2≥(0.75×HD. At the connection part of the contour straight line 35 and the bead heel portion 20, the height H5 from the bead toe 26 in the tire radial direction fell within the range of (0.3×H1)≥H5≥(0.25×H1). Further, the pneumatic tires 1 in Examples 1 to 16 were different in the thickness W1 of the sidewall portion 4 at the tire maximum width position 40, the thickness W2 at the bead filler tip 12a, the thickness W3 of the bead portion 10 at the position of the bead core outer circumferential surface 11a, the height H3 from the bead toe 26 to the turned-up tip 132a in the tire radial direction, the height H4 from the bead toe 26 to the bead filler tip 12a in the tire radial direction, and the presence or absence of a thermoplastic resin film for the innerliner 18.

As a result of conducting the evaluation tests through use of those pneumatic tires 1, as shown in FIG. 4A to FIG. 4D, it has been revealed that the pneumatic tires 1 in Examples 1 to 16 achieved reduction in tire weight while ensuring the durability of the bead portion as compared to Conventional Examples 1 and 2 and Comparative Examples 1 to 4. That is, the pneumatic tires 1 in Examples 1 to 16 were able to achieve reduction in weight while ensuring durability.

1. A pneumatic tire, comprising:
a pair of sidewall portions provided on both sides of a tire equatorial plane in a tire lateral direction;
a pair of bead portions provided inward of the pair of sidewall portions in the tire lateral direction, each of the pair of bead portions including a bead core formed in an annular shape;
a bead filler provided outward of the bead core in a tire radial direction; and
a carcass provided over a space between the pair of bead portions, the carcass being folded back from an inner side to an outer side of the bead core in the tire lateral direction,
wherein a tire outer surface contour line, which is a contour line from the sidewall portion to the bead portion on an outer surface in the tire lateral direction in a meridian cross-section, includes:
an arc, which has a center on a tire axial line passing a tire maximum width position, passes the tire maximum width position and is connected to a bead heel portion of the bead portion; and
a straight line, which has one end connected to the arc and the an other end connected to the bead heel portion,
a region of the arc from a position at which the straight line is connected and the tire maximum width position forms the tire outer surface contour line,
a connection part of the arc and the bead heel portion and a connection part of the straight line and the bead heel portion are set such that a height H1 in the tire radial direction from a bead portion innermost end, which is an end on an innermost side of the bead portion in the tire radial direction, to the tire maximum width position and a height H5 in the tire radial direction from the bead portion innermost end fall within a range of (0.3×H1)≥H5≥(0.25×H1), and
a connection part of the arc and the straight line is set such that the height H1 in the tire radial direction from the bead portion innermost end to the tire maximum width position and a height H2 in the tire radial direction from the bead portion innermost end fall within a range of (0.9×H1)≥H2≥(0.75×H1).

2. The pneumatic tire according to claim 1, wherein a relationship of a thickness W1 of the sidewall portion in the tire maximum width position, a thickness W2 of the sidewall portion at a position of an end of the bead filler outward in the tire radial direction, and a thickness W3 of the bead portion at a position of an end of the bead core outward in the tire radial direction falls within a range of (2.8×W2)≥W3≥(2.1×W2) and falls within a range of (1.7×W1)≥W2≥(1.2×W1).

3. The pneumatic tire according to claim 1, wherein a height H3 in the tire radial direction from the bead portion innermost end to an end of a turned-up portion, which is a portion folded back outward of the bead core in the tire lateral direction in the carcass, on an outer side in the tire lateral direction and the height H1 in the tire radial direction from the bead portion innermost end to the tire maximum width position fall within a range of (0.75×H1)≥H3≥(0.65×H1).

4. The pneumatic tire according to claim 1, wherein a height H4 in the tire radial direction from the bead portion innermost end to the end of the bead filler outward in the tire radial direction and the height H1 in the tire radial direction from the bead portion innermost end to the tire maximum width position fall within a range of (0.6×H1)≥H4≥(0.5×H1).

5. The pneumatic tire according to claim 1,
wherein an air penetration preventing layer is provided on an inner surface of the pneumatic tire, and
a thermoplastic resin film is used for the air penetration preventing layer.

6. The pneumatic tire according to claim 2, wherein a height H3 in the tire radial direction from the bead portion innermost end to an end of a turned-up portion, which is a portion folded back outward of the bead core in the tire lateral direction in the carcass, on an outer side in the tire lateral direction and the height H1 in the tire radial direction from the bead portion innermost end to the tire maximum width position fall within a range of (0.75×H1)≥H3≥(0.65×H1).

7. The pneumatic tire according to claim 6, wherein a height H4 in the tire radial direction from the bead portion innermost end to the end of the bead filler outward in the tire radial direction and the height H1 in the tire radial direction from the bead portion innermost end to the tire maximum width position fall within a range of (0.6×H1)≥H4≥(0.5×H1).

8. The pneumatic tire according to claim 7,
wherein an air penetration preventing layer is provided on an inner surface of the pneumatic tire, and
a thermoplastic resin film is used for the air penetration preventing layer.
